(19) United States
(12) Patent Application Publication
(10) Pub. No.: US 2020/0273484 A1
(43) Pub. Date: Aug. 27, 2020

(54) Birdwatching System

(71) Applicant: Michael B. Doerr, Hampton Falls, NH (US)

(72) Inventors: Michael B. Doerr, Hampton Falls, NH (US); Michael B. Solka, Austin, TX (US); Martin A. Hunt, Austin, TX (US)

(21) Appl. No.: 16/799,126

(22) Filed: Feb. 24, 2020

Related U.S. Application Data
(60) Provisional application No. 62/809,852, filed on Feb. 25, 2019.

(51) Int. Cl. G10L 25/51; G06F 3/0481; G06F 3/16; H04R 1/40; H04R 1/04; H04R 3/00; H04N 5/225; H04R 1/02

(52) U.S. Cl. CPC G10L 25/51; G06F 3/04817; G06F 3/165; H04R 1/406; G06F 1/163; H04R 3/005; H04N 5/2253; H04R 1/025; H04R 1/04

(57) ABSTRACT

A birdwatching system for identifying, locating, and tracking birds of interest while birdwatching. The birdwatching system may comprise an apparatus, such as shaft, which includes a plurality of microphones located on a distal end of the shaft for capturing audio signals of a bird, and possibly video cameras for producing video of the birds. The birdwatching system may further comprise a device, such as the user's tablet device, which receives audio data from the plurality of microphones and processes the audio data (locally of via a remote server) to determine a bird species and location of the bird. The device may then display an icon in a map of the surrounding area representing the location of the bird. The display may further selectively display information regarding the identified bird species. The birdwatching system may detect, locate, display and track information on a plurality of birds simultaneously.

### PRIORITY CLAIM

This application claims benefit of priority to U.S. Provisional Application No. 62/809,852 titled “Directional Birdwatching System” and filed on Feb. 25, 2019 which is hereby incorporated by reference in its entirety as if fully and completely set forth herein.

### FIELD OF THE INVENTION

The field of the invention generally relates to systems for detecting, characterizing and presenting information regarding nearby wildlife, and in particular a system to facilitate birdwatching.

### DESCRIPTION OF THE RELATED ART

Birdwatching is considered to be one of the fastest growing outdoor activities worldwide. Traditionally, the common equipment used for this experience is the human natural auditory and visual system and a physical bird species reference manual or guide. The experience may be enhanced visually through binoculars once an auditory sound or visual cue is identified. Other equipment used are high-performance cameras where the user manually tracks the target of interest to capture unique observations. More recently, bird electronic reference manuals have been released via various interactive mediums. However, improvements in the field are desired.

### SUMMARY OF THE EMBODIMENTS

Various embodiments are presented of a system and method for performing one or more of identifying, directionally finding, and tracking birds of interest while birdwatching. The system may also be used to create a real-time and/or non-real-time interactive birdwatching experience for the user.

In some embodiments, the birdwatching system may comprise an apparatus, such as shaft, which includes a plurality of microphones located on a distal end of the shaft. The microphone array may be configured to receive audio signals of a bird and produce resultant audio signals as well as directional information of the received audio signals. The shaft may be configured to be supported by a backpack carried by a user such that the distal end of the shaft protrudes out of the backpack, and preferably near or above the head of the user. The apparatus may further comprise one or more video cameras located at the distal end of the shaft and configured to capture video images of bird(s). The apparatus may further comprise one or more speakers located at the distal end of the shaft and configured to generate bird sounds for attracting desired species of birds.

The birdwatching system may further comprise a device which includes a display, a non-transitory memory medium, and a processor communicatively coupled to the plurality of microphones, the display and the non-transitory memory medium. The device may be configured to receive audio data from the plurality of microphones, wherein the audio data corresponds to the audio signals of the bird, and wherein the audio data includes the directional information. The device may be further configured to process the audio data to determine a first bird species and a first location of the bird. The display may be configured to display a map of an area surrounding the microphone, and may also display a first icon indicating the first location of the bird on the map. The display may further selectively display information regarding the first bird species. The first icon may be selectable to display information associated with the first bird species.

The device may be a user equipment (UE) device carried by the user while birdwatching. The birdwatching system may further comprise a wearable audio presentation device, such as headphones, communicatively coupled to the UE, which can play the audio data for the user.

In some embodiments, the device is configured to transmit the first audio data to a server using the radio. The server may be configured to process the audio data, using one or more stored bird sound waveforms, to determine a first bird species of the bird, and to further determine a first location associated with the audio data. The device may then receive information from the server indicating a first bird species and a first location associated with the first audio data, based on the transmitted first audio data. The device may then display: 1) a map of an area surrounding the microphone, 2) a first icon on the map indicating the first location of the first bird, and 3) information regarding the first bird species.

The birdwatching system may be useable to detect, locate, and display information on a plurality of birds simultaneously. Thus when audio signals of multiple birds are received concurrently, the device may process each of the audio signals and present different respective icons on the display indicating locations of each of the detected birds. Alternatively, the device may transmit the plurality of audio signals corresponding to the different birds to the server for processing, and may receive back species and location information for each of the birds for presentation to the user on the display.

Some embodiments may comprise a server for use in bird watching, wherein the server may comprise a processor and a non-transitory memory medium. The server may be configured to receive audio data of a bird over a wide area network from the device (UE) of a user (birdwatcher). The audio data may be generated from a plurality of microphones, wherein the audio data comprises audio signals corresponding to sounds of the bird and includes direction information indicating a direction of the bird relative to the plurality of microphones. The server may process the audio data, using one or more stored bird sound waveforms, to determine a first bird species of the bird, and to further determine a first location associated with the audio data. The stored bird sound waveforms may be stored on the server itself or may be accessed from a separate database. The server may then generate information regarding the first bird species and the first location and transmit the information regarding the first bird species and the first location over the wide area network back to the user's device for presentation to the user. For example, the information may be useable to present the first bird species and the first location on a display of a user.

Some embodiments may also comprise a software application (software app) used for configuring a UE device, such as a smart phone or tablet (e.g., iPad) to perform various birdwatching operations as described herein. The software application may be stored on a non-transitory computer accessible memory medium comprising program instructions. The program instructions may be executable to cause the device to 1) receive audio data from a plurality of microphones, wherein the audio data corresponds to bird sounds of a bird and includes directional information indicating a location of the bird; 2) transmit the audio data to a server using a radio; 3) receive resultant information from the server indicating a first bird species of the bird and a first location of the bird, based on the transmitted audio data; and 4) display, on the display, a map of an area surrounding the microphone, and a first icon indicating the first location of the bird on the map.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present invention may be obtained when the following detailed description of the preferred embodiment is considered in conjunction with the following drawings, in which:

FIG. 1 illustrates a person (birder) using the birding system while birdwatching;

FIG. 2 illustrates various components of the birder system;

FIG. 3 illustrates a display device in the birder system which displays a location and type of bird detected by the birder system;

FIG. 4 illustrates various sensor types that may be used in the birder system;

FIG. 5 is a block diagram illustrating components in the birder system, e.g., in a user equipment (UE) device that is used in the birder system;

FIG. 6 is flowchart of the receipt of single sensor data through processing and delivery of the experience to the audience;

FIG. 7 illustrates the flowchart of FIG. 6 in relation to an example practical realization of the system with respect to locality of processing and database;

FIG. 8 illustrates the flowchart of FIG. 6 in relation to an example practical realization of the system with respect to variation in locality of processing and database;

FIG. 9 is a flowchart of the receipt of multiple sensor data through processing and delivery of the experience to the audience;

FIG. 10 illustrates the flowchart in FIG. 9 in relation to an example practical realization of the system with respect to locality of processing and database;

FIG. 11 illustrates the flowchart of FIG. 9 in relation to an example practical realization of the system with respect to variation in locality of processing and database; and

FIG. 12 illustrates the example of system interactivity delivered within an example presentation experience device.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS OF THE INVENTION

### Terms

The following is a glossary of terms used in the present application:

Auditory Sensor—Auditory Sensor is made up of one or more auditory sensors.

Video/Image Sensor—Video/Image Sensor is comprised of one or more video/image sensors. The Video/Image Sensor is not limited to only the human visible spectrum.

Other Sensor—Other Sensor is made up of one or more other (e.g. LIDAR) sensors.

Sensor Processing—Sensor Processing includes initial processing of data which may include organization of data to be transported to the Processing System.

Function Processing—Function Processing includes Pre-Processing, Main-Processing, and Post-Processing of the Function. Function Processing may include multiple pre-processing, processing, and post-processing sub-functions.

Immersive Experience Processing—Immersive Experience Processing is the combining of all the data to create a multidimensional organization of the data based on the sensor input to the system in preparation for supporting the human interface, delivery of data through a simple experience to a more complex augmented visualization experience or full virtual reality experience.

Birder Controlled Experience—Birder Controlled Experience is the human interface delivering the experience of the system to the Birder. This presentation experience device can be anything from a smart phone, tablet, to smart glasses to a full virtual reality multi-dimensional theater experience.

Locality of Processing and Database—Locality of Processing and Database data may include performing processing and access of database data on single device to across multiple devices to remote devices, e.g. cloud servers.

Embodiments of the directional birdwatching system described herein may operate to enhance the birdwatching experience of bird watchers, from the “Casual Birder” to the “Hard Core Birder”. This system intends to bring the wonder of the outdoors coupled with encyclopedic knowledge together to drive an interactive augmented or virtual reality experience for the Birder. The Birder may be fully in control of the Birder immersive experience. The experience can be enjoyed in various ways, including directly interactive with the environment, remotely experienced, or synthesized from recorded data. The system may be designed to support sharing and interactive socialization of the recorded data and experiences with the Birding community. Additionally, the system may be configured to become interactive with the environment being sensed, supporting actively tracking the object of interest to promoting interactivity with the object of interest.

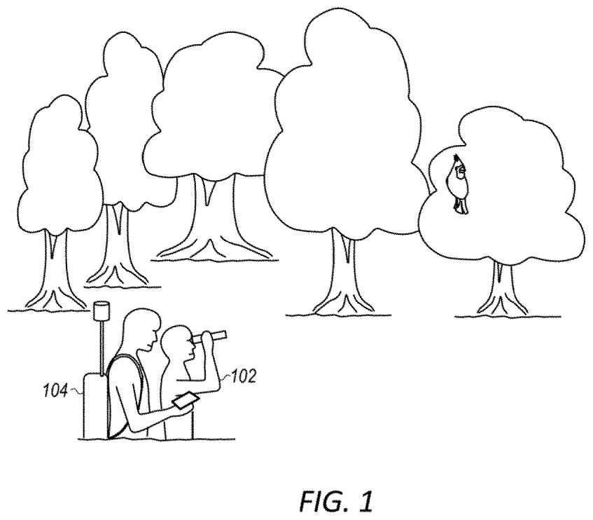

FIG. 1 illustrates a person (referred to sometimes herein as a birder) 102 using a birder system as described herein. As shown, the person may carry or wear a backpack 104 or other similar baggage, wherein the backpack 104 contains or holds a birding system as described herein. The birding system may operate to enhance the experience of the birder by allowing the birder to more easily perform one or more of detect, locate, identify and/or track nearby birds. It is noted that although the system is described herein in conjunction with birds and birding, embodiments described herein may be used with any of various wildlife.

As used herein, the term “backpack” is intended to include any of various types of bags that may be worn or carried, including standard backpacks worn over one or both shoulders, bags that may be worn across the waist (e.g., fanny packs), as well as other types of bags or containers that may be worn or carried. As shown in FIG. 1, the birding system 110 may include a sensor assembly 112, wherein the sensor assembly 112 may be in the form of a shaft (or pole) that may at least partly protrude (or extend outside of) the backpack, preferably above the backpack as shown.

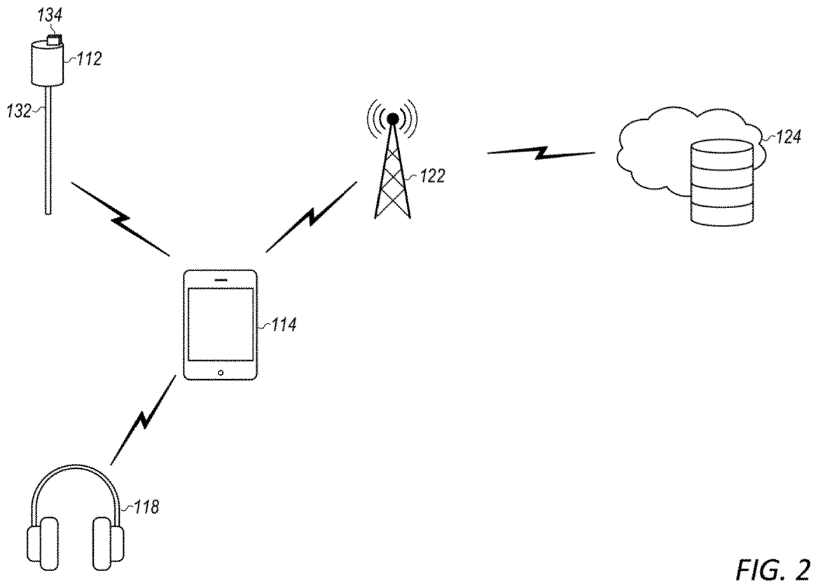

FIG. 2 illustrates the various elements of the birder system, shown outside of the backpack for convenience. As shown, the birder system may include a processing/display system 114. The sensor assembly 112 may be coupled to the processing system 112, such as in a wired manner. In some embodiments, the processing/display system 114 may be operable to communicate with a server (cloud server) 124 (e.g., through an intermediate cellular base station 122), where the cloud server 124 is located remotely from the birder system. Headphones 118 may also be communicatively coupled to the processing/display system 114.

The sensor assembly 112 may include a shaft (e.g., a pole) 132, wherein the term “shaft” refers to any extension apparatus. The shaft is used for extending sensors outside of the backpack. One end of the shaft 132 may include a sensor head or device 134 which may contain one or more sensors. The sensors may be at a distal end of the shaft, meaning that they are near or at one end of the shaft. The shaft 132 may be a telescoping pole (an extendable pole) whereby the user can selectively extend the shaft or pole 132 outside of the backpack to a desired height or distance. For example, the shaft 132 may be extended to a distance such that the sensor head 134 is outside of the backpack, and possible above the head of the birder, as shown in FIG. 1. This may provide a better “line of sight” for receiving audio signals and capturing video signals.

The sensor head 134 may include one or more auditory sensors or microphones that are adapted to receive audio signals from the nearby environment, including sounds of birds (e.g., birdsong). The one or more microphones may comprise a plurality of directional microphones (a directional microphone array) for detecting an approximate orientation of objects generating sounds received by the microphones, e.g., for detecting directional locations of birds based on received bird sounds. For example, the sensor head may include a plurality of (an array of) directional microphones oriented in various directions such that sounds received by the microphones can be used to pinpoint an approximate direction, and hence location, of an object generating the sounds (e.g., the location of a bird). The sensor assembly 112 may also include one or more video sensors for receiving video data of the environment. The video cameras may be triggered to acquire video data in response to detection of bird audio data. In some embodiments, the antenna assembly may also include an antenna for performing wireless communication, such as a cellular antenna for communicating with a cellular base station. The sensor assembly 112 may further include speakers for generating sounds, such as bird sounds, to attract bird species of interest.

The processing/display system 114 may comprise a processing element (not shown) and other electronic components or circuitry. The processing system may be contained within a chassis or housing. In some embodiments, the processing system 114 may be part of the sensor assembly 112. In this embodiment the processing system 114 may be situated inside the backpack, e.g., where the backpack is used to hold the processing system, and possibly at least a portion of the sensor assembly, for convenience. In other words, the birder may wear or carry the backpack, where the backpack stores or holds at least a portion of the birder system. As noted above, the sensor(s), e.g., microphone(s), video sensor(s), etc., may be located remotely from the processor system, e.g., may be in the form of sensor(s) on or near the end of a shaft (e.g., telescopic pole) extending out of the backpack, where a lower portion of the shaft resides at least partly in the backpack or is strapped to the outside of the backpack. Alternatively, the processing/display system 114 may be situated outside of the backpack.

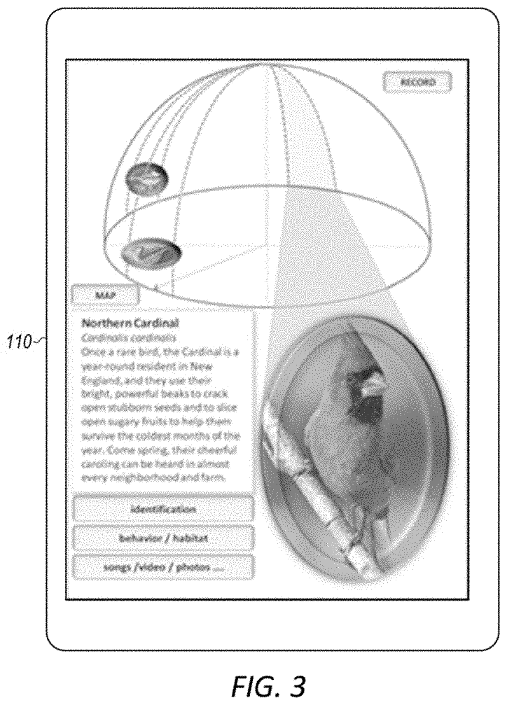

In a preferred embodiment, a user's existing user equipment (UE) device, such as a tablet, e.g., iPad or cellular smart phone device, may function as the processing/display system 114. The UE 114 may store and execute a software application (app) that configures the UE to perform various of the operations described herein. The UE 112 may be coupled to the sensor assembly 112 in a wired (or wireless) manner. The UE 112 includes a display device which displays various data acquired by the sensors on the sensor assembly, as described more in FIG. 3. The UE 112 may be communicatively coupled to headphones 118 in a wired manner, or in a wireless manner, e.g., via Bluetooth. The headphones 118 may enable the birder to more easily and/or more conveniently listen to bird sounds received by the microphones. Thus the birder system may be designed to use or employ a user's existing UE device, e.g., cell phone or iPad.

The UE 112 (e.g., cell phone or iPad) may include cellular communication capability. As shown, the UE 112 may communicate in a wireless manner to a cellular base station 122, thereby enabling the UE 112 to communicate with a server (e.g., cloud server) 124. The UE 114 may provide the various sensor information to the cloud server 124, and the cloud server 124 may perform various processing functions on behalf of the birder system, such as identifying, locating and/or tracking birds detected by the sensors on the sensor assembly 112. The cloud server 124 can then provide this result information back to the UE 114 for presentation to the user. The use of cloud server 124 allows for a central repository for various bird songs, which can be updated regularly by the various birders using the server. The cloud server 124 may also facilitate the sharing of a birding experience over social media with other birders, possibly in real time as the bird watching experience is occurring. When the birder is in a more remote location without access to a nearby cell tower, the birder system may employ satellite communications to communicate with the cloud server 124.

In some embodiments, instead of using cloud server 124 for processing, the UE 112 performs most or all of the above processing locally, such as identifying, locating and/or tracking birds based on information provided by the sensors on the sensor assembly 112. In this embodiment, the cloud server may not be needed for real-time operation, and may be accessed primarily for updates as new bird songs are added to the cloud server repository and may be downloaded to the UE 114. Local processing may be desired in instances where the birder is in a remote location far from any cell towers or other communications equipment, and hence where access to a cloud server may not be possible or financially practical. In this scenario, the user may download a set of bird sounds and other bird species information associated with birds that are likely to be encountered on to his UE device for use while birdwatching.

In operation, the user (birder) may be walking in an environment carrying a backpack containing the birder system, as shown in FIG. 1. The auditory sensors (microphones) on the sensor head 134 at one end of shaft 132 may capture bird sounds from birds present within the environment and provide these audio signals to the UE 112, either in a wired or wireless fashion. The acquired bird sounds may also be provided to the user's speakerphones. The UE 114 may receive these audio signals and use these signals to determine an approximate location of the bird generating the sound. For example, the UE 114 may determine an approximate direction from which the sounds originated, and also possibly an approximate distance from which the sounds originated. Directional data may be determined from the directional antennas, as is known in the art. Distance information may be determined using signal strength information or other means, as is known in the art.

Alternatively, the audio signals received from the microphones on the sensor assembly 112 may be provided by the UE 114 to the cloud server 124. For example, the sensor assembly 112 may provide the audio signals to the user's UE device (cell phone or tablet), which may then transmit these audio signals wirelessly (e.g., in a cellular manner) to a cellular base station/cellular network 122 (or satellite), and then over the Internet to the cloud server 124.

In another embodiment, the birder system may include a processing system that is separate from the user's existing UE, which may include more sophisticated wireless communication capability that performs this function, using an antenna contained within the sensor assembly. This system may be desired in remote locations where greater transmit power is desired, e.g., for satellite communication. It is noted that use of the user's existing UE device may be preferred, as this leverages the user's existing processor, cellular electronics and antenna, thus providing reduced cost.

The cloud server 124 may store or have access to a repository (database) of different bird songs. The cloud server 124 may receive the audio signals from the birder system carried by the user and determine the type (or species) of bird that generated the sounds. For example, the cloud server 124 may compare (e.g., using correlation or convolution) the received audio signals with various stored bird song data and determine the best match, and hence determine the bird species that originated the sounds. In some embodiments, the cloud server 124 may use more advanced artificial intelligence (AI)/machine learning techniques to aid in identifying bird species based on the received audio signals as well as information regarding the geographic location of the user.

The cloud server 124 may also perform the location processing, e.g., may use the received audio signals from the directional antennas, as well as information regarding which directional antennas received the sounds, the strength of the sounds, etc. and may determine the approximate location of the bird which originated the sounds. In some embodiments, the cloud server 124 may receive audio and location information from two or more birders in the same geographic area and employ triangulation to aid in determining a more precise location of the bird.

The cloud server 124 may then provide the species information and location information back to the birder system (the UE 114). The UE 114 may receive the species information and location information and display this data on the UE's display. As noted above, the UE 114 may store and execute an application (app) that operates to perform the various functions described herein, including receiving and displaying this information.

The server 124 may also store birding experiences based on its processing of the received sensor data. The stored birding experience may include the bird sounds received and recorded by the microphones, video of the birds captured by video sensors (video cameras) on the sensor assembly, and determined location and species information. These birding experiences may be uploaded to social media or otherwise may be shareable with other birders, or may be recorded and re-played at a later time to recreate the experience for the user or other users. Thus one or more of the UE 114 or the server may store the detected bird audio signals and the resultant processed information (e.g., location and species) so that the experience can be shared on social media and/or re-played at a later time.

FIG. 3 shows an example display presented by the birder system, i.e., presented on the display of the UE 114. As shown, the UE 114 may present a map of the area surrounding the birder, e.g., using GPS and mapping software (e.g., Google Earth). Based on the location and identification functions performed by the birder system (which as noted above may be performed locally by the UE or by a separate server), the display may show the locations of one or more birds in the area surrounding the user, as indicated by an icon associated with each bird. An icon for each detected bird is displayed on the map corresponding to the determined location of the detected bird. Thus, where multiple birds are detected, the display may present an icon for each detected bird, where the icons are positionally located on the display corresponding to their actual locations in the surrounding environment. The icon displayed may be different for each bird species, and thus the appearance of the icon may visually indicate a type or species of each of the bird(s). In other words, the display may present a different icon for each type or species of bird, where one or more of a shape, pattern, or color of the icon corresponds to and visually indicates a particular bird species.

Each bird icon presented on the display may be selectable by the user to cause additional information regarding the bird species to be displayed. For example, the user may select an icon on the display to cause a picture of the bird species to be displayed and/or to cause information about the bird species to be displayed. Thus the birder system may also selectively display a prestored picture of the bird species as well as information regarding the species. The icon may also be selectable to cause pre-stored sounds of the bird species to be displayed, or to cause a recording of the bird sound that was just detected to be re-played to the user.

Movements of the bird(s) may also be tracked on the display. For example, when the microphone array detects movement of a bird to a different location, this new audio information may be received and processed, either locally (e.g., by the UE) or remotely (by the server), and new location information may be generated and provided to the UE. This may cause the display to present updated information on the bird's movements (the bird's location), as detected by the birder system or cloud server 124 based on updated information received by the sensors. Thus, the icon representing the bird may be moved to a new position on the display to represent the determined change in location of the bird.

The birder system is capable of processing a plurality of birds at the same time, and thus the user may see a corresponding plurality of icons on the display representing the various detected birds in the vicinity. The birder system is also capable of tracking a plurality of birds at the same time.

Thus, based on audio signals received by the microphone area on the sensor assembly 112, the location and identification of one or more birds may be determined, and information associated with the location and identification of one or more birds may be presented on the display.

In some embodiments, the birder system is capable of receiving information from other nearby birder systems regarding locations and species of birds in the proximate area. Thus, if one birder system detects a certain species of bird (such as a rare species), the system may be configured to broadcast this information (e.g., using a cellular transmission) to other birder systems in the area. This may cause each of the other birder systems to provide an alert to its respective user, and display an icon on their respective displays indicating the bird species, possibly on their maps. In some embodiments, where the bird detected by another system is too far away from the user to appear on his respective map as presently displayed, the other birder systems may cause their maps to “zoom out” so that the bird can appear on their respective display. This provides information to other users so that they can move closer to the detected species of bird for their own watching experience.

The following is an overview of the operation of a system in use by a birder. The system is able to identify bird related sounds in the environment, determine specie(s), and determine relative location of the specie(s), and track the specie(s) detected to the birder. The system is also able to document and record this information, including approximate absolute location. The presentation experience may be delivered via a handheld mobile device, known today as a tablet, whereby the birder may interactively bring up more information on the specie(s) detected. These findings and recordings may be shared socially with others electronically. The system can also provide a real-time enhanced hyper-sensory and/or surround sound auditory experience, or playback recorded or shared recorded experiences.

The birder system may also have the ability to reverse the process, i.e., the system may be used to actively stimulate the environment with auditory signals (to generate artificial bird sounds) to solicit a particular specie(s) response. More particularly, the sensor head 134 may also contain one or more speakers for generating bird sounds in order to attract nearby birds. The user may use his/her UE device to select one or more bird species for audio generation, wherein the UE may generate an audio waveform provided either by the birder system (or cloud server) that is output from the speaker to simulate presence of the bird species. In some embodiments, user selection of a particular bird species is transmitted to the cloud server 150, and the cloud server 150 provides the desired bird audio waveform back to the birder system for presentation on the speakers.

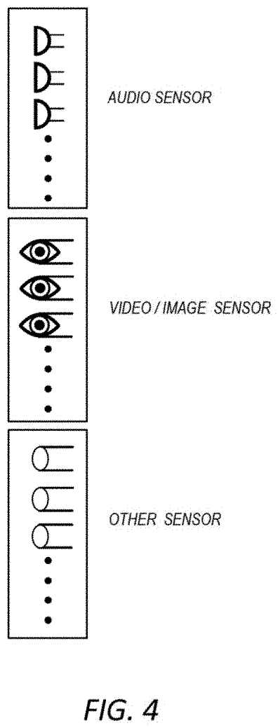

FIG. 4 illustrates a representation different types of sensors in the birder system. As shown, the sensors in the birder system may comprise one or more of: 1) one or more audio sensors, 2) one or more image/video sensors, and/or 3) one or more other sensors. These sensors may receive data from the environment, and as noted above speakers may be present to perform stimulation of the environment or both. For each sensor type, the sensors may be comprised of one or more sensors of that particular type. For example, an auditory sensor may be comprised of multiple auditory detection devices (microphones) that can be used to create a phased array auditory detection approach.

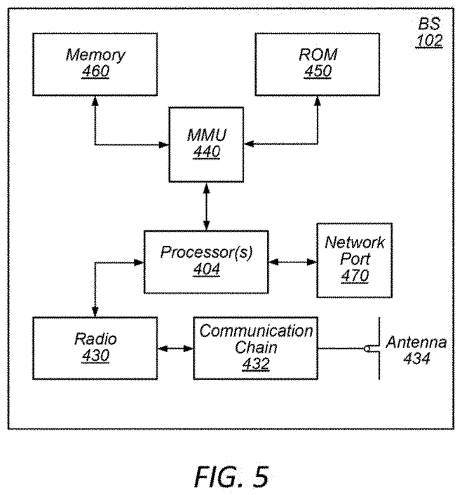

FIG. 5 is a block diagram illustrating an example processing system, e.g., an example block diagram of an example UE, according to some embodiments. As shown, the UE 114 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, flash memory 310) and/or to other circuits or devices, such as the display circuitry 304, radio 330, connector I/F 320, and/or display 360.

As shown, the SOC 300 may be coupled to various other circuits of the UE 114. For example, the UE 114 may include various types of memory (e.g., including flash 310), a connector interface 320 (e.g., for coupling to a computer system, dock, charging station, etc.), the display 360, and wireless communication circuitry 330 (e.g., for cellular, Bluetooth, Wi-Fi, GPS, etc.). The UE device 114 may include at least one antenna for performing wireless communication with base stations and/or other devices.

The UE 114 may include hardware and software components for implementing methods for the UE 114 to perform any of various of the bird watching operations described herein.

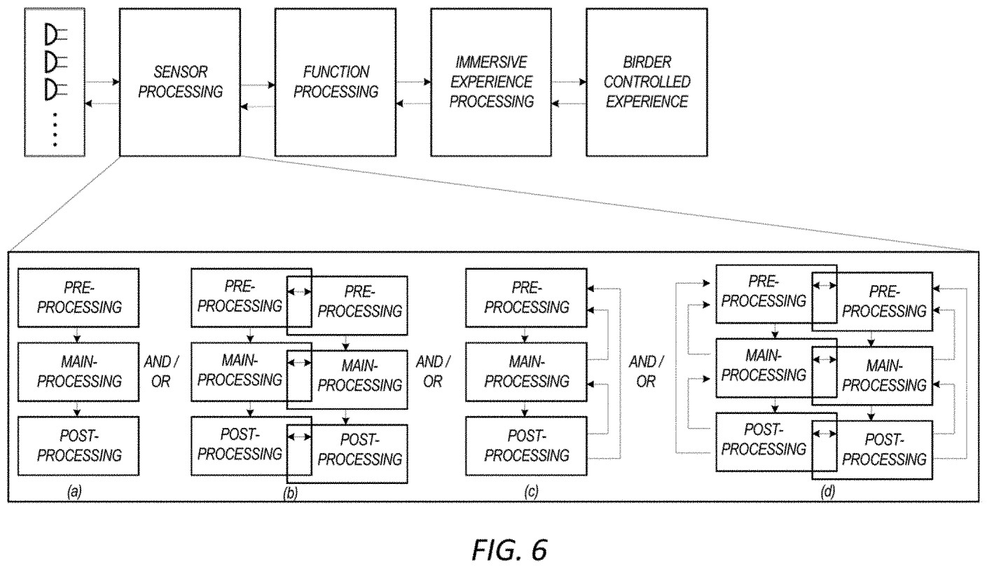

FIG. 6 illustrates a system flowchart showing one embodiment of operation. As shown the birding system receives data through its sensors. The received data enters into a block called Sensor Processing, where the data is processed depending on the sensor type, i.e., different types and levels of processing may be performed on the data depending on the data type (audio, image, video, etc.). The type of audio processing may include filtering or enhancing the audio signal to remove background noise, etc. For example, a bandpass filter may be applied to the received audio waveform, wherein the bandpass filter is designed to pass audio frequencies corresponding to birdsong and suppress others. As another example, in the case of an auditory sensor, the data may be filtered and processed to reduce artifacts caused by the auditory sensor device itself.

The processed sensor data may then be provided to a Function Processing block. In some embodiments, Function Processing may be performed locally on the processing system of the birder system. If Function Processing is not occurring locally, the processing system may perform packetization of the received sensor data for transmission of this data to the cloud server for processing.

The Function Processing, block may include multiple processing steps to convert the resulting sensor data received from the Sensor Processing block into data to be used by the Immersive Experience Processing block. The Function Processing block may include three steps referred to as Pre-processing, Main-processing, and Post-processing. The operation of the Function Processing block is broken out into three steps to potentially support the unique receiving and unpacking of sensor data, organization of data for Main processing, an iterative nature of some Main processing algorithms that may require data reorganization, and the different Locality of Processing and Database schemes. The following provides four different embodiments of the Function Processing operation.

The Function Processing 412 illustrates a straight-forward dataflow processing of the three steps, where Pre-processing is performed first, followed by Main-processing and then followed by Post-processing. The Function Processing 414 illustrates multiple subsystem function processing steps that are interactive with each other, potentially sharing or dependent on each result to produce a solution. The Function processing 416 illustrates the operation 412 described above with the addition of multiple feedback loops enabling iterative function processing. The Function processing 418 combines the algorithmic representation of 414 and 416. For the auditory sensor example there are potentially one or more Function Processing sub-systems that are operating in parallel.

As noted above, the birder system may operate to identify the species of the bird whose sound is detected. To support species identification, the Function Processing may implement one or more of correlation, convolution and/or deep learning/artificial intelligence techniques. The methods may involve comparing an acquired waveform of bird sound detected by the microphones to each of a plurality of stored waveforms representing different bird species. The correlation method may perform a correlation between the recorded bird sound and various stored bird sound waveforms, whereas the convolution method may perform a convolution between the recorded bird sound and various stored bird sound waveforms. Each processing architecture may be represented by 412 through 414 for a real-time implementation.

To support specie relative direction/location, space time frequency adaptive processing techniques may be used to facilitate a three-dimensional mapping of audio over time representation of the environment. To support tracking of the object or specie of interest, potentially predictive vector correlation and segmentation techniques based on the sounds shape in multi-multidimensional space can be used. Again, all of these subsystems and subsystems of subsystems can potentially be facilitated in a Function processing architecture represented by 412 through 416.

The Immersive Experience Processing block may prepare the raw result data from the Function block for delivery to the experience medium, e.g., a tablet such as an iPad. The experience medium may support various levels of interactivity. The processing may allow for complete or subset recording of the sensed environment and for simplification of content to address target experience. The processing may support interactivity with the experience, supporting changes in operational experience, delivery of ancillary content for the experience, etc. The resulting experience could be a simple notification, to augmented reality, to a full virtual reality system.

The Birder Controlled Experience is the Birder Interface in the context of an experience, where the features of the experience and its capabilities are directly and indirectly determined by the types of Sensors, Sensor Processing, and Function Processing the system supports. This enables a generic platform to potentially support many levels of features provided capabilities are available and enabled.

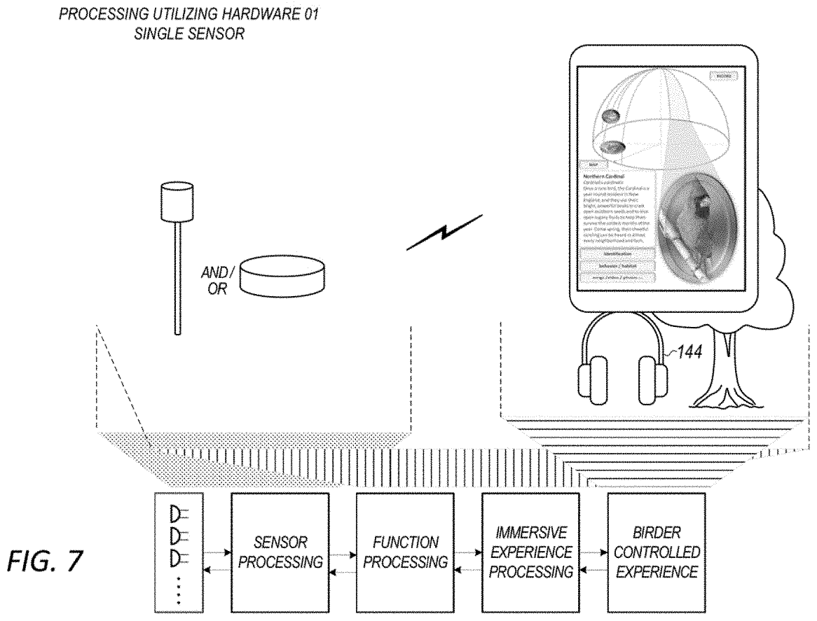

FIG. 7 illustrates the system flowchart in FIG. 6 in relation to an example practical realization of the system where most or all of the processing occurs in the sensor assembly 112. In this embodiment, the Sensor and Sensor Processing is performed in the location of the sensor assembly 112. In other words, the sensor assembly may include the processing device whose block diagram is shown in FIG. 5. The Function Processing and Immersive Experience Processing may also be co-located with the Sensor Processing. In other words, the processing system contained in the sensor assembly 112 may perform the Function Processing and Immersive Experience Processing However, these functions may also be performed on the presentation experience device (e.g., iPad) or split between the two, where the presentation experience device represented here is currently described as a tablet and headphones. Communication between these two devices, i.e., between the processing system in the sensor assembly 112 and the UE device 114, is envisioned to be through a standard commercial interface such as Bluetooth or Wi-Fi or tethered (wired) or some custom communication interface. In other words, the birding system may have first processing capability in the sensor assembly which performs at least a part of the processing, and the user's iPad, configured with a software app, may perform another part of the processing, to collectively perform identification, location detection and tracking of birds.

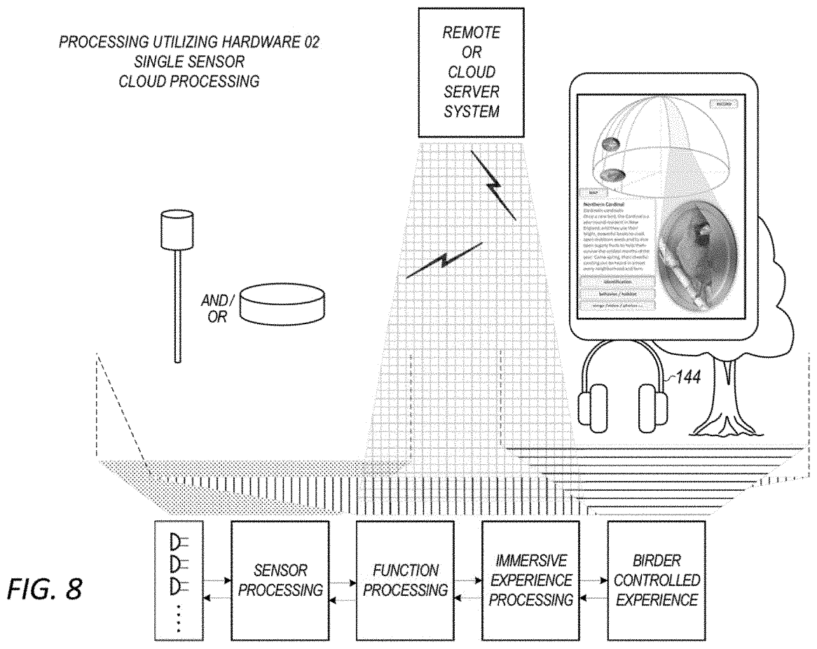

FIG. 8 illustrates the system flowchart in FIG. 6 in relation to an example practical realization of the system using cloud-based processing. Expanding on FIG. 6, locality of Processing and Database for the Function Processing and Immersive Experience Processing may not necessarily be performed locally, but remotely in a cloud or cloud server system device. Advantages to this may include more processing resources, access to larger database(s) of encyclopedic like information which may result in enriching the Birder experience or reduce system deployment costs. Thus, in this embodiment acquired sensor data may be provided over a wide area network to a cloud server, wherein the cloud server performs the processing to accomplish bird species detection, location identification and possibly tracking.

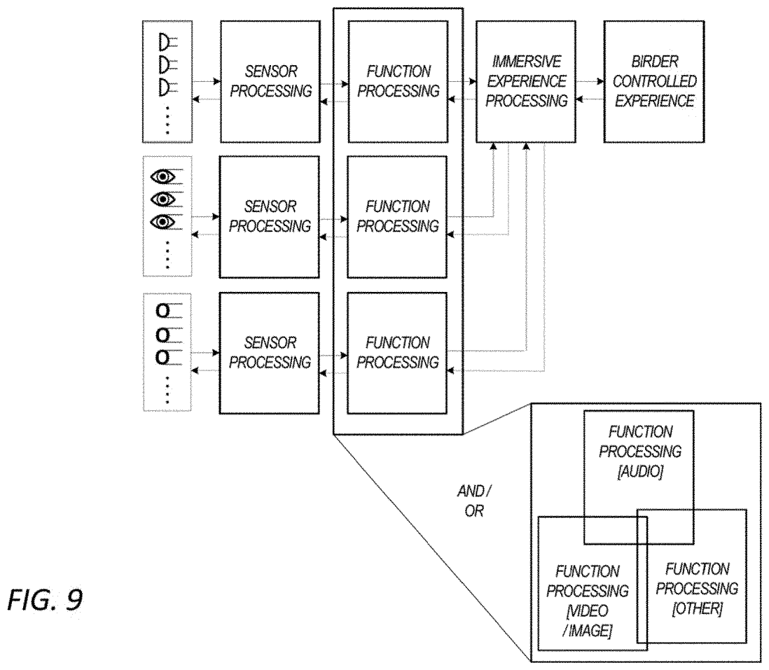

FIG. 9 illustrates a system flowchart of the ingestion of multiple sensor data through processing and delivery of the experience to the audience. This system embodiment expands on the flowchart system described in FIG. 6 with the introduction of multiple sensor subsystems and how the subsequent Processing sub-systems may or may not process the data. Multiple Sensors may allow the Function Processing sub-systems of each Sensor to cooperatively work together to create a more integrated and precise solution to the environment detected and thus further enhance the delivered experience.

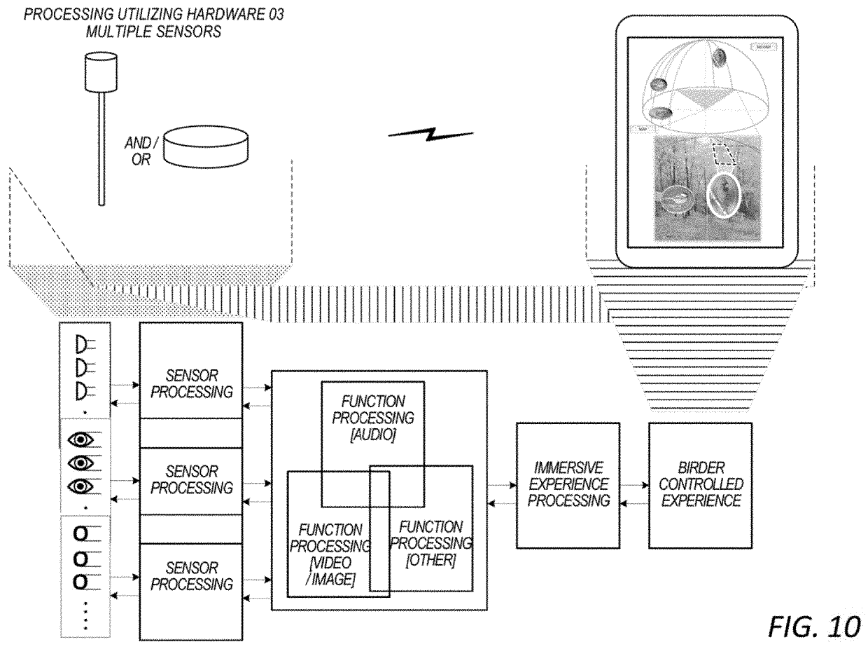

FIG. 10 illustrates the system flowchart in FIG. 9 in relation to an example practical realization of the system with respect to locality of processing and database. In this embodiment, the multiple Sensors and Sensor Processing sub-systems are contained in the sensor assembly 112, i.e., in the location of the Sensor. FIG. 10 is similar to FIG. 7, with the primary exception being that multiple sensor processing sub-systems may be employed. The multiple Function Processing subsystems and Immersive Experience Processing may be co-located with the Sensor Processing sub-systems. Alternatively, the multiple Function Processing subsystems and Immersive Experience Processing may also be performed on the presentation experience device 114 (e.g., iPad, wearable display glasses, VR headset, etc.) or split between the two. The presentation experience device represented here is currently described as a tablet and headphones. Communication between these two devices is envisioned to be through a standard commercial interface such as Bluetooth or Wi-Fi or tethered (wired) or some other communication interface.

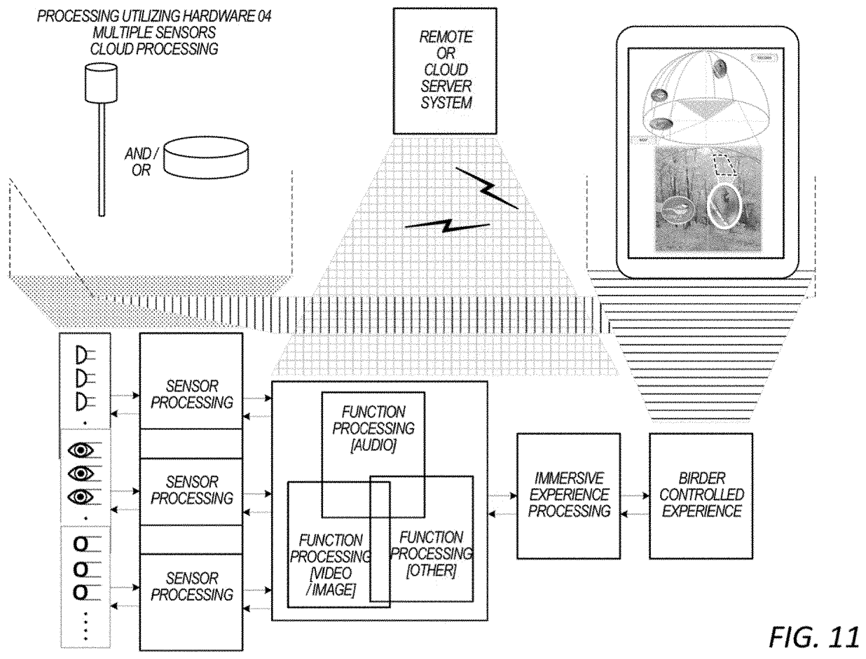

FIG. 11 illustrates the system flowchart in FIG. 9 in relation to an example practical realization of the system with respect to variation in locality of processing and database. Similar to FIG. 8, the Function Processing and Immersive Experience Processing may not necessarily be performed locally, but remotely in a cloud or cloud server system device. Advantages to this may include more processing resources, access to larger database(s) of encyclopedic like information which may or may not result in enriching the birder experience or reduce system deployment costs. Communication between the UE 114 and the cloud server may be through a standard commercial interface such as a combination of Wi-Fi and/or Unicast (4G/5G) cellular and/or some other communication interface and/or custom communication interface.

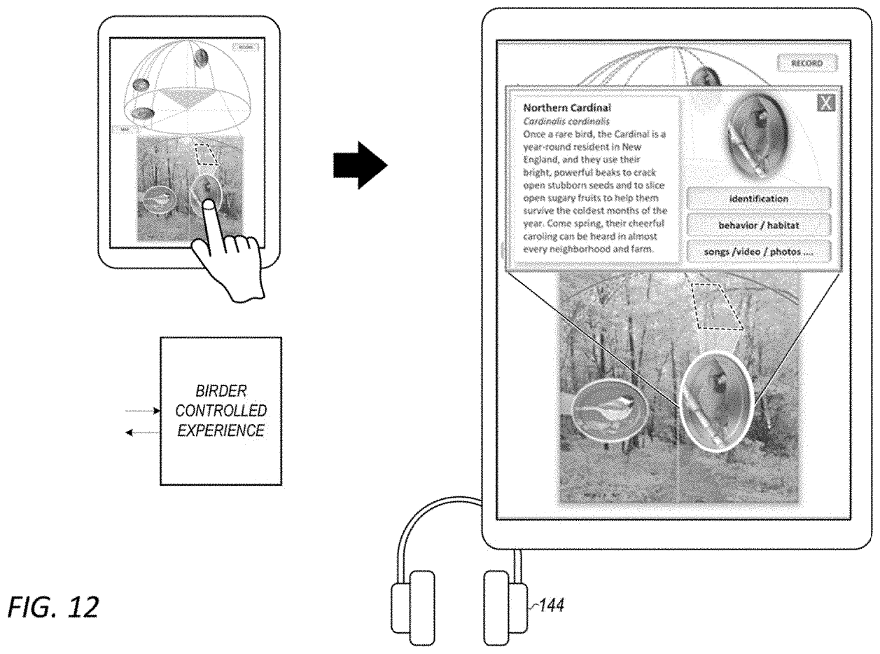

FIG. 12 illustrates the example of system interactivity delivered within an example presentation experience device. In this embodiment the presentation experience device is a handheld tablet where the birder interacts with the tablet through the touch screen or voice control. FIG. 12 illustrates the combined experience of audio and video/imagery in the presentation of identification, relative location direction, and tracking of the bird specie(s). This may represent the result of the processing system flowchart outlined in FIG. 9.

Additionally, guidance to specie(s) or unique experiences can be derived from the detection and tracking capabilities in the Birder's current experience or though social electronic interaction with other Birders real-time or past recorded and shared experiences.

The social network experience may provide for tracking and sharing of experiences in real-time and non-real-time, including species list, locations, etc.

The Directional Birdwatching System is not just limited to Birding but applicable to many species and objects of interest.

Although specific embodiments have been described above, these embodiments are not intended to limit the scope of the present disclosure, even where only a single embodiment is described with respect to a particular feature. Although the embodiments above have been described in considerable detail, numerous variations and modifications will become apparent to those skilled in the art once the above disclosure is fully appreciated. It is intended that the following claims be interpreted to embrace all such variations and modifications.

Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A birdwatching system, comprising:
a plurality of microphones configured to receive audio signals of a bird and configured to produce directional information of the received audio signals;
a display;
a non-transitory memory medium; and
a processor communicatively coupled to the plurality of microphones, the display and the non-transitory memory medium, wherein the processor is configured to:
receive audio data from the plurality of microphones, wherein the audio data corresponds to the audio signals of the bird, and wherein the audio data includes the directional information;
process the audio data to determine a first bird species and a first location of the bird;
display, on the display, a map of an area surrounding the microphone, wherein the first location of the bird is indicated on the map by a first icon, wherein the first bird species is also indicated on the display.

2. The birdwatching system of claim 1,
wherein the plurality of microphones are installed on an end of a shaft.
wherein the shaft is configured to be supported by a backpack carried by a user.

3. The birdwatching system of claim 1,
wherein the display, the non-transitory memory medium, and the processor are comprised as part of a user equipment (UE) device carried by the user.

4. The birdwatching system of claim 1,
wherein the first icon is selectable to display information associated with the first bird species.

5. The birdwatching system of claim 1, further comprising:
a wearable audio presentation device;
wherein the processor is further configured to:
play the audio data through the wearable audio presentation device.

6. A birdwatching system, comprising:
a plurality of microphones configured to receive first audio signals of a bird and configured to produce first directional information of the received first audio signals;
a display;
a radio;
a non-transitory memory medium; and
a processor communicatively coupled to the plurality of microphones, the display and the non-transitory memory medium, wherein the processor is configured to:
receive first audio data from the plurality of microphones, wherein the first audio data corresponds to the first audio signals of a first bird, and wherein the first audio data includes the first directional information;
transmit the first audio data to a server using the radio;
receive information from the server indicating a first bird species and a first location associated with the first audio data, based on the transmitted first audio data;
display, on the display, 1) a map of an area surrounding the microphone, 2) a first icon on the map indicating the first location of the first bird, and 3) information regarding the first bird species.

7. The birdwatching system of claim 6,
wherein the display, the radio, the non-transitory memory medium, and the processor are comprised as part of a user equipment (UE) device carried by a user;
wherein the UE device is configured to be carried by a user during birdwatching;
wherein the UE device is communicatively coupled to the plurality of microphones.

8. birdwatching system of claim 6,
wherein the plurality of microphones are installed on a distal end of a shaft.
wherein the shaft is configured to be supported by a backpack carried by a user.

9. The birdwatching system of claim 6,
wherein the display is operable to display information associated with the first bird species in response to user input.

10. The birdwatching system of claim 6,
wherein the processor is further configured to:
receive second audio data from the plurality of microphones, wherein the second audio data corresponds to the audio signals of a second bird, and wherein the second audio data includes second directional information;
transmit the second audio data to the server using the radio;
receive information from the server indicating a second bird species and a second location associated with the second audio data, based on the transmitted audio data;
display, on the display, 1) a second icon on the map indicating the first location of the second bird, and 2) information regarding the second bird species.

11. A birdwatching system, comprising:
a radio;
a non-transitory memory medium; and
a processor communicatively coupled to a plurality of microphones, the display and the non-transitory memory medium, wherein the processor is configured to:
receive audio data from a plurality of microphones, wherein the audio data corresponds to bird sounds of a bird and includes directional information indicating a location of the bird;
transmit the audio data to a server using the radio; and
receive information from the server indicating a first bird species of the bird and a location of the bird, based on the transmitted audio data;
a display coupled to the processor, wherein the display is configured to display 1) a map of an area surrounding the microphone, and 2) a first icon on the map indicating the location of the bird.

12. The birdwatching system of claim 11,
wherein the display, the radio, the non-transitory memory medium, and the processor are comprised as part of a user equipment (UE) device carried by a user;
wherein the UE device is configured to be carried by a user during birdwatching;
wherein the UE device is communicatively coupled to the plurality of microphones.

13. The birdwatching system of claim 11,
wherein the display is further configured to display information regarding the first bird species.

14. An apparatus for use in birdwatching, the apparatus comprising:
a shaft;
a plurality of microphones located on a distal end of the shaft and configured to receive audio signals from a bird and provide audio data corresponding to the received audio signals, wherein the audio data includes directional information of the bird for use in determining an approximate location of the bird.

15. The apparatus of claim 14, further comprising:
one or more video cameras located on the distal end of the shaft and configured to capture video images of the bird.

16. The apparatus of claim 14, further comprising:
one or more speakers located on the distal end of the shaft and configured to generate bird sounds.

17. A server for use in bird watching, the server comprising;
a non-transitory memory medium; and
a processor communicatively coupled to the non-transitory memory medium,
wherein the processor is configured to:
receive audio data of a bird over a wide area network, wherein the audio data is generated from a plurality of microphones, wherein the audio data comprises audio signals corresponding to sounds of the bird, wherein the audio data further includes direction information indicating a direction of the bird relative to the plurality of microphones;
process the audio data, using one or more stored bird sound waveforms, to determine a first bird species of the bird, and to further determine a first location associated with the audio data;
generate information regarding the first bird species and the first location; and
transmit the information regarding the first bird species and the first location over the wide area network,

18. The server of claim 17,
wherein the information is useable to present the first bird species and the first location on a display of a user.

19. The server of claim 17,
wherein, in processing the audio data, the server is configured to access stored bird sound waveforms from a database of bird sound waveforms.

20. The server of claim 17,
wherein the memory medium stores bird sound waveforms for each of a plurality of bird species;
wherein, in processing the audio data, the server is configured to access the stored bird sound waveforms from the memory medium.

21. A non-transitory computer accessible memory medium comprising program instructions executable to:
receive audio data from a plurality of microphones, wherein the audio data corresponds to bird sounds of a bird and includes directional information indicating a location of the bird;
transmit the audio data to a server using a radio;
receive information from the server indicating a first bird species of the bird and a first location of the bird, based on the transmitted audio data;
display, on the display, 1) a map of an area surrounding the microphone, and 2) a first icon indicating the first location of the bird on the map.
